(19) United States
(12) Patent Application Publication
(10) Pub. No.: US 2009/0071751 A1
(43) Pub. Date: Mar. 19, 2009

(54) PORTABLE AERIAL PLATFORM

(75) Inventors: FRANK SCHMIDT, Leduc (CA); MANFRED SCHMIDT, Edmonton (CA); NORMAN RUST, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: PERMACORP INDUSTRIES INC., Edmonton (CA)

(21) Appl. No.: 11/857,277

(22) Filed: Sep. 18, 2007

(51) Int. Cl. B66F 11/04

(52) U.S. Cl. 182/63.1; 182/148

(57) ABSTRACT

The invention is directed to a vertically and horizontally-controlled, retractable aerial platform mountable on the bed of a vehicle for supporting a person or materials. The aerial platform includes a base, at least one support arm, a first support member, a second support member, a platform, and actuation means. The aerial platform may further include a collapsible frame. The aerial platform is vertically and horizontally-controlled, allowing a workman to adjust both the height and extension distance of the platform so that work functions can be readily performed. The aerial platform is portable, compact and suitable for use in a variety of commercial vehicles.

### FIELD OF THE INVENTION

The present invention relates to a retractable aerial platform mountable on a vehicle for supporting a person or materials.

### BACKGROUND

In the oil and construction industries, it is often necessary to provide aerial platforms to elevate workmen above ground level in outdoor and indoor locations to permit repairs to elevated structures or to lift materials to elevated sites. Safety measures and fall protection are required for such oilfield site servicing and construction environments.

Several prior art aerial platforms exist; however, they tend to be extremely heavy, bulky and complex, making the aerial platforms difficult to operate, store, lift, transport, assemble or disassemble. Prior art aerial platforms often include inadequate bracing or guardrails, unsafe access or other structural flaws, often contrary to occupational health and safety regulatory requirements. What is needed is an improved aerial platform which mitigates the disadvantages of the prior art.

### SUMMARY OF THE INVENTION

The present invention is directed to a retractable aerial platform. In one aspect of the invention, the invention comprises a vertically and horizontally-controlled, retractable aerial platform mountable on a vehicle having a substantially horizontal bed with a longitudinal axis, the aerial platform comprising:
a) a base mounted on the bed;
b) at least one support arm having a first end and a second end, the first end being attached to the base;
c) a first support member pivotally attached to the second end of the at least one support arm, the first support member being movable between a closed position wherein it rests in a plane that is substantially parallel to the bed, and an open position wherein it rests in a substantially vertical orientation in a plane that is perpendicular to the bed;
d) a second support member pivotally attached to the first support member, the second support member being movable between a closed position wherein it rests in a plane that is substantially parallel to the first support member, and an open position wherein it rests in a substantially horizontal plane perpendicular to the first support member when in its open vertical position, and perpendicular to the longitudinal axis of the bed, wherein the second support member is movable along the length of the first support member;
e) a platform mounted on the second support member, wherein the platform is movable along the length of the second support member; and
f) actuation means for moving the first and second support members between the open and closed positions, for moving the second support member along the length of the first support member and for moving the platform along the length of the second support member.

In one embodiment, the platform further comprises a collapsible frame mounted on the platform moveable between a first collapsed position wherein the frame is substantially parallel to the platform and a second erect upright position. In one embodiment, the base comprises first and second spaced leg members which extend downwardly from the base for attachment to the bed. In one embodiment, the first support member comprises a frame having first and second spaced parallel side members reinforced by crossbeams, and a lifting member moveable longitudinally between the first and second side members, the second support member being pivotally attached to the lifting member.

In one embodiment, the first support member further comprises a plurality of spaced parallel rollers arranged in pairs within the first and second side members for lowering or raising the lifting member longitudinally between the first and second side members. In one embodiment, the first support member further comprises a chain-based system for lowering or raising the lifting member longitudinally between the first and second side members.

In one embodiment, the collapsible frame comprises side rails positioned on the edges of the platform and extending vertically, and hand rails and crossbeams extending horizontally to connect the opposite side rails.

In one embodiment, the actuation means is selected from a hydraulic system, an electric system, or a hydraulic and electric based system. In one embodiment, the actuation means for moving the first and second support members between open and closed positions comprises a hydraulic cylinder having a piston rod, the hydraulic cylinder being pivotally mounted to the base and the piston rod being pivotally mounted to the first support member.

In one embodiment, the actuation means for moving the platform along the length of the second support member comprises an electric actuator driven by an electric motor to extend or retract the platform horizontally along the second support member away from or towards the first support member. In one embodiment, the electric actuator comprises a worm gear.

In one embodiment, the actuation means for moving the second support member along the length of the first support member comprises an electric motor positioned on the first support member and associated with gears to drive a cable-driven system to enable vertical upward and downward movement of the lifting member. In one embodiment, the cable-driven system comprises upper and lower roller bushings at the ends of the first support member, a spring within the upper end of the lifting member, cable running from the gears to the lower roller bushing and connected to the spring, and cable running from the gears to the upper roller bushing and connected to the lower end of the lifting member.

In another embodiment, the platform further comprises a control unit selected from a portable hand control unit, a vehicle positioned control unit, or a ground level control unit.

In a further embodiment, the platform is grated or comprises a metal floor grille or lattice. In a further embodiment, the platform further comprises two opposing end members and two opposing lateral members attached to the platform and frame to form an enclosure. In yet a further embodiment, the support arm is branched forming a “v” shape, the apex of the v being pivotally attached to the first support member.

In one aspect of the invention, it comprises a retractable aerial platform mountable on a substantially horizontal surface, the aerial platform comprising:
a) a base mounted on the horizontal surface;
b) at least one support arm having a first end and a second end, the first end being attached to the base;
c) a first support member pivotally attached to the second end of the at least one support arm, the first support member being movable between a closed position wherein it rests in a plane that is substantially parallel to the horizontal surface, and an open position wherein it rests in a substantially vertical orientation in a plane that is perpendicular to the horizontal surface;
d) a second support member pivotally attached to the first support member, the second support member being movable between a closed position wherein it rests in a plane that is substantially parallel to the first support member, and an open position wherein it rests in a substantially horizontal plane perpendicular to the first support member in its open vertical position, wherein the second support member is movable along the length of the first support member;
e) a platform mounted on the second support member, wherein the platform is movable along the length of the second support member; and
f) actuation means for moving the first and second support members between the open and closed positions, for moving the second support member along the length of the first support member and for moving the platform along the length of the second support member.

### BRIEF DESCRIPTION OF THE DRAWINGS

The invention will now be described by way of an exemplary embodiment with reference to the accompanying simplified, diagrammatic, not-to-scale drawings.

FIG. 1 is a diagrammatic representation of a retractable aerial platform of one embodiment of the present invention in the closed position when installed on the bed of a vehicle.

FIG. 2 is a diagrammatic representation of a retractable aerial platform of one embodiment of the present invention.

FIG. 3 is a diagrammatic representation of a retractable aerial platform of one embodiment of the present invention.

FIG. 4 is a diagrammatic representation of a side view of a retractable aerial platform of one embodiment of the present invention.

FIG. 5 is a diagrammatic representation of a retractable aerial platform of one embodiment of the present invention.

FIG. 6 is a diagrammatic representation of a retractable aerial platform of one embodiment of the present invention.

FIG. 7 is a diagrammatic representation of a retractable aerial platform of one embodiment of the present invention.

FIG. 8 is a diagrammatic representation of a top view of a retractable aerial platform of one embodiment of the present invention.

FIG. 8a is an enlarged view of a partially cut away section of a retractable aerial platform of FIG. 8, showing the detail of an attachment means.

FIG. 8b is an enlarged view of a partially cut away section of a retractable platform of FIG. 8, showing the detail of an attachment means.

FIG. 9 is a diagrammatic representation of a retractable aerial platform of one embodiment of the present invention.

FIG. 10 is a diagrammatic representation of one embodiment of the present invention mounted to horizontal surface.

### DETAILED DESCRIPTION OF PREFERRED EMBODIMENTS

The present invention provides for a retractable aerial platform. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

“Horizontal” means a plane that is substantially parallel to the plane of the horizon. “Vertical” means a plane that is perpendicular to the horizontal plane.

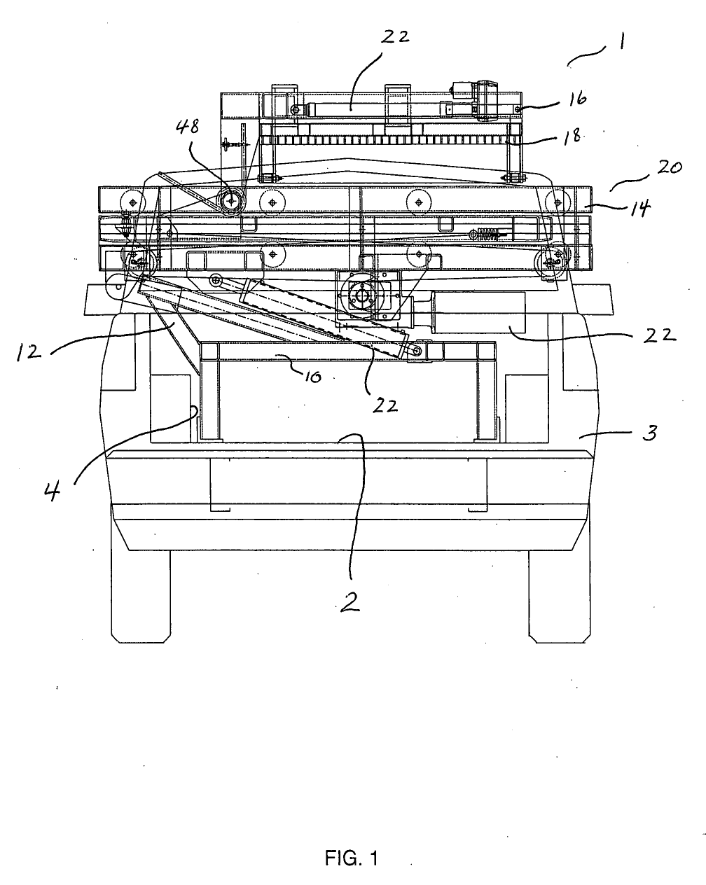

The invention will now be described having regard to the accompanying Figures. The retractable aerial platform (1) is shown generally in FIG. 1 to include a base (10), at least one support arm (12), a first support member (14), a second support member (16), a platform (18), a frame (20), and actuation means (22). FIG. 1 shows the retractable aerial platform (1) mounted onto the bed (2) of a commercial or other motor vehicle (3), for example, a truck, a pick-up truck, a half-ton truck, a three-quarter-ton truck, or a one-ton truck. In one embodiment, the vehicle (3) is a half-ton truck or a three-quarter-ton truck.

The base (10) is sized so as to be fully accommodated within the side walls of the bed (2), but with minimal intrusion to allow space for other equipment within the bed (2). In one embodiment, the base (10) takes up 30% of the bed (2), with 70% of the bed (2) available for other equipment. The base (10) comprises first and second spaced leg members (24, 26) which extend downwardly from the base (10) and are secured to the bed (2) and frame (4) of the vehicle (3) by suitable attachment means including, for example, brackets (28, 30) or screws, to allow the retractable platform (1) to be installed or released from the bed (2) and frame (4) of the vehicle (3). It will be understood by those skilled in the art that if desired, the retractable aerial platform (1) can be permanently attached to the bed (2) by welding or other known techniques if the vehicle (3) is to be used regularly or solely in elevated working environments. The base (10) can be formed of any suitable material, although for strength and to withstand cold and adverse field conditions, the base (10) may be formed of aluminum or steel.

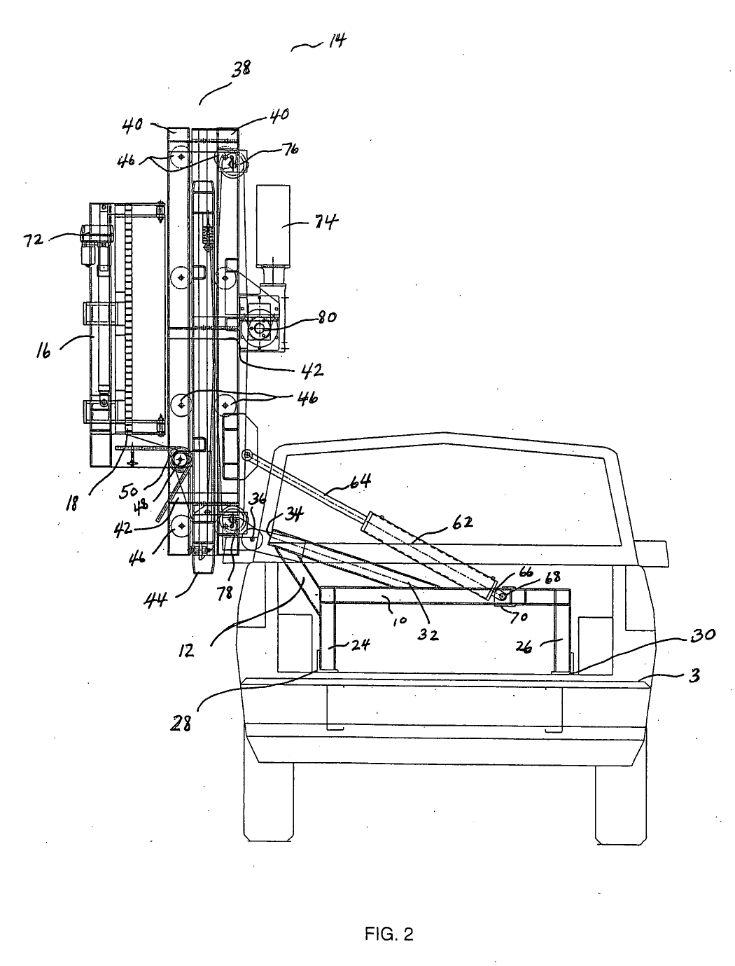

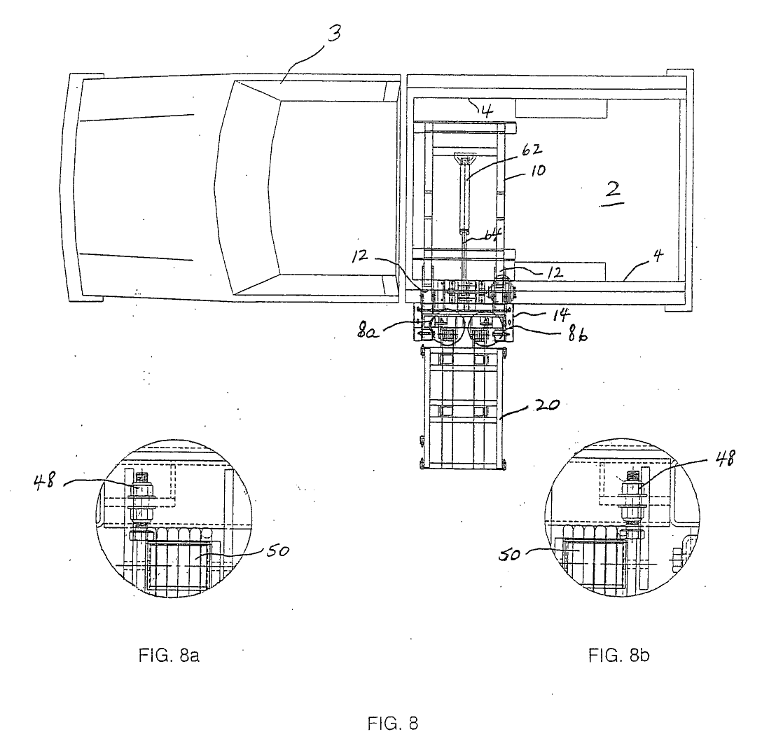

The support arm (12) has first and second ends (32, 34), of which the first end (32) is attached to the base (10) and the second end (34) is pivotally attached to the first support member (14). In one embodiment, there is at least one support arm (12). In one embodiment, there are two support arms (12), one on each side of the base (10), as shown in FIG. 8. In one embodiment, the support arm (12) is branched and formed in the shape of a “V,” with the ends (32) of the “V” attached to the base (10) by welding, and the apex of the “V” having a pivot (36) formed thereon for attachment to the first support member (14). The support arm (10) can be formed of any suitable material including, for example, aluminum or steel. The first support member (14) is pivotally attached to the second end (34) of the support arm (12), so as to be movable between a closed position wherein it rests in a plane that is substantially parallel to the bed (2) (as shown in FIG. 1), and an open position wherein it rests in a substantially vertical orientation in a plane that is perpendicular to the bed (2) (as shown in FIGS. 2-7 and 9). The first support member (14) comprises a frame (38) having first and second spaced parallel side members (40) which may be reinforced by crossbeams (42). In one embodiment, the first and second parallel side members (40) may be provided with cushioned bumpers along their outer lengths or full-length side rubber stoppers to cushion the first support member (14) from other components (i.e., preventing damage) as the retractable platform is moved into the closed position.

The first support member (14) includes a lifting member (44) which is moveable longitudinally between the first and second side members (40) which remain stationary during the movement of the lifting member (44). In order to lower or raise the lifting member (44), the first support member (14) includes a plurality of spaced parallel rollers (46) arranged in pairs within the first and second side members (40). The first support member (14) can be formed of any suitable material including, for example, aluminum or steel. The rollers (46) can be formed of any suitable material including, for example, metal or polymers such as, for example, neoprene. It will be appreciated by those skilled in the art that a chain-based system could also be used to lower or raise the lifting member (44).

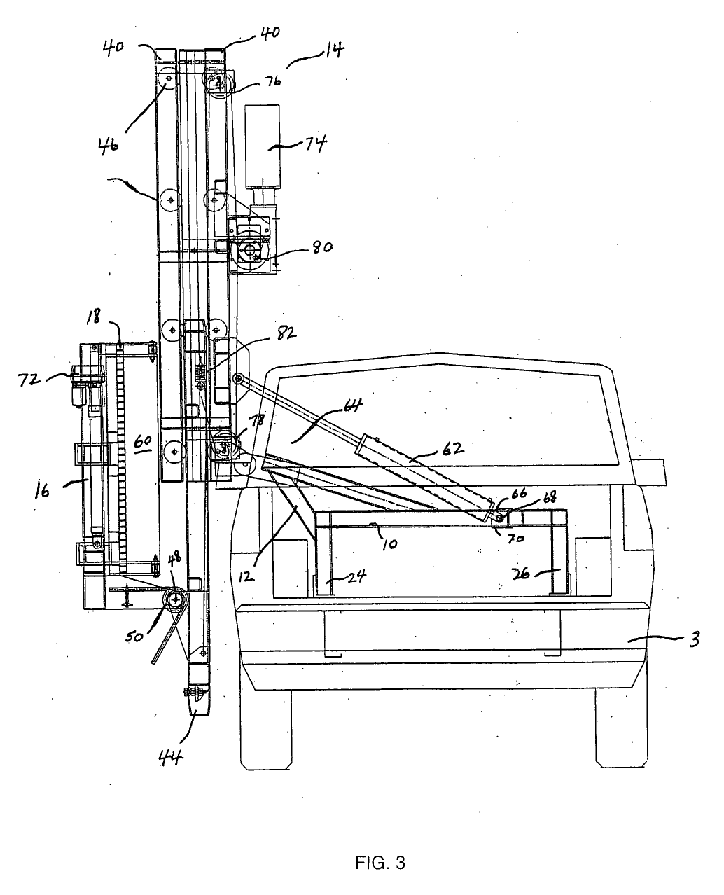

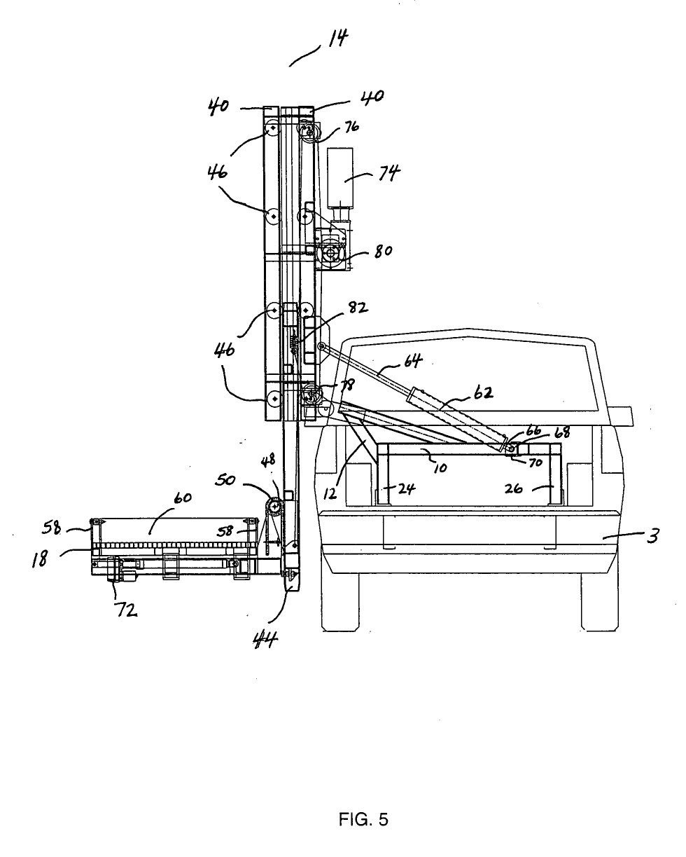

The second support member (16) is pivotally attached to the lifting member (44) of the first support member (14), and is moveable between a closed position wherein it rests in a plane that is substantially parallel to the bed (2) (as shown in FIG. 1), and an open position wherein it rests in a substantially horizontal plane parallel to the bed (2) and perpendicular to the longitudinal axis of the bed (2) (as shown in FIG. 5) and perpendicular to the first support member (14) when in its open vertical plane. As the second support member (16) is pivotally attached by a pivot (48) to the lifting member (44), it is moveable along the length of the first support member (14), as shown in FIGS. 2 and 3 which illustrate its transition between the closed and open positions. The second support member (16) can be formed of any suitable material including, for example, aluminum or steel.

The platform (18) is mounted on the second support member (16) by suitable attachment means including, for example, a hinge or an axel bolt (48), as shown in FIGS. 8a and 8b. The platform (18) is moveable in two directions, namely horizontally back and forth along the length of the second support member (16) so as to extend outwardly from or retract towards the first support member (14), and vertically up or down due to attachment of the second support member (16) to the lifting member (44). In one embodiment, the platform (18) is moveable three to five feet horizontally and two to ten feet vertically. The platform (18) can be formed of any suitable material including, for example, aluminum, steel or wood. Workmen are generally prohibited from working on platforms covered with snow, ice or accumulated debris except to remove the hazards. In one embodiment, the platform (18) is grated or comprises a metal floor grille or lattice to provide a slip-resistant surface, improving tread grip and safety during normal or adverse conditions.

In one embodiment, a spring adjustment is included to control the descent of the second support member (16) from its closed position to its open position. The spring adjustment is dependent upon factors such as, for example, the combined platform weight and the second support member weight. In one embodiment, the spring adjustment ranges from about 85-100 degrees. FIGS. 8a and 8b illustrate the spring (50) through which the axel bolt (48) extends to attach the platform (18) to the second support member (16). As the second support member (16) descends into its open position, the spring (50) is gradually compressed allowing the second support member (16) to descend in a controlled manner.

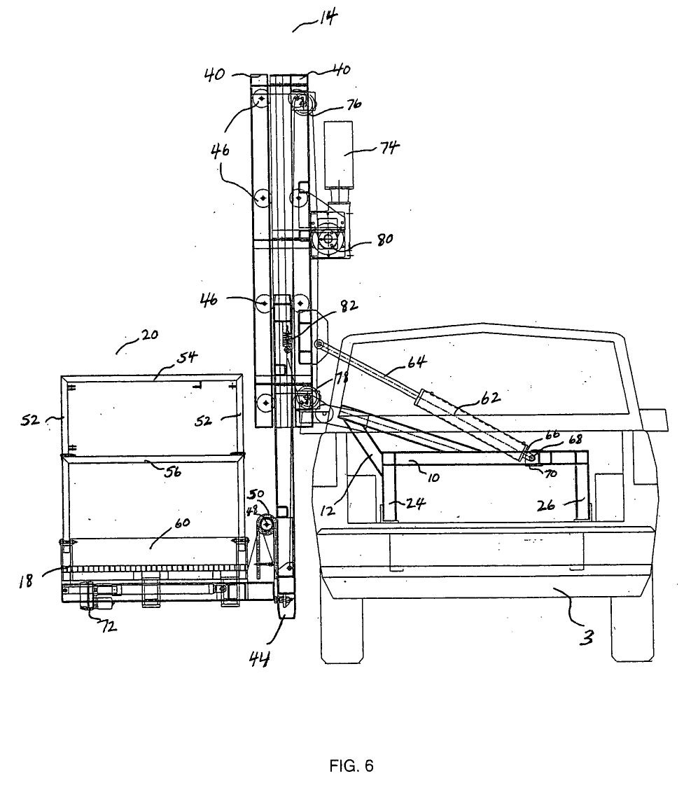

A frame (20) is mounted on the platform (18) by suitable attachment means including, for example, screws or bolts. The frame (20) is constructed from any suitable material such as aluminum or steel. The frame (20) includes side rails (52) positioned on the edges of the platform (18) and extending vertically. Hand rails (54) and crossbeams (56) for barring a fall extend horizontally to connect opposite side rails (52). In one embodiment, two opposing end members (58) and two opposing lateral members (60) are attached to the platform (18) and frame (20) to form an enclosure commonly referred to as a “toe board” in the art at the base of the platform (18), providing additional fall protection. In one embodiment, the frame (20) is collapsible into a closed position as shown in FIGS. 1-5, and erectable into an upright position as shown in FIGS. 6-9. Use of a collapsible frame (20) pre-mounted to the platform (18) affords convenience; however, it will be appreciated by those skilled in the art that a non-collapsible frame could be readily attached and released from the platform (18).

The retractable aerial platform (1) includes actuation means (22) for driving the movement of the first and second support members (14, 16) between their open and closed positions, for moving the second support member along the length of the first support member, and for moving the platform (18) on the second support member (16). In one embodiment, the actuation means (22) comprises a combination hydraulic and electric based system. In one embodiment, the actuation means (22) comprises a 12V DC hydraulic and electric based system. In one embodiment, the actuation means comprises a hydraulic system. In one embodiment, the actuation means comprises an electric system.

The operation of hydraulic cylinders is commonly known to those skilled in the art and will not be discussed in detail. Briefly, a hydraulic pump, powered by an appropriate power source, drives oil to the hydraulic cylinder which converts the energy transferred to the oil by the pump to a mechanical output, namely the linear thrust of a piston rod. Where power requirements for the retractable platform (1) or any component thereof is described, one skilled in the art will realize that any suitable power source may be used, including, without limitation, the vehicle's electrical system, rechargeable and non-rechargeable batteries, self-contained power units, or other appropriate sources.

In one embodiment, the actuation means for moving the first and second support members (14,16) between their open and closed positions (22) comprises a hydraulic cylinder (62) having a piston rod (64). The hydraulic cylinder (62) is double-acting, namely able to control a load in two directions. The hydraulic cylinder (62) is pivotally mounted at one end (66) on a pivot (68) secured to the base (10) by suitable attachment means including, for example, a bracket (70). The piston rod (64) is pivotally mounted to the first support member (14) to provide sufficient output force to extend or retract the first and second support members (14, 16) between their open and closed positions.

In one embodiment, an electric actuator (72) driven by an electric motor is used to extend or retract the platform (18) horizontally along the second support member (16) away from or towards the first support member (14) respectively. In one embodiment, the electric actuator (72) comprises a worm gear consisting of a shaft with screw thread (the worm) which meshes with a toothed wheel (the worm wheel) to convert rotary motion into linear motion, thereby extending or retracting the platform (18) horizontally along the second support member (16) away from or towards the first support member (14) respectively.

In one embodiment, an electric motor (74) is positioned on the first support member (14) to drive a cable-driven system to enable vertical upward and downward movement of the lifting member (44). The first support member (14) includes upper and lower roller bushings (76, 78) at its ends. Gears (80) associated with the electric motor (74) drive the roller bushings (76, 78), along which stainless steel cable (not shown) is run. Cable runs from the gears (80) to the upper roller bushing (76) and extends to connect to the lower end of the lifting member (44). Cable also runs from the gears (80) to the lower roller bushing (78) and extends to a spring (82) within the lifting member (44). For moving the lifting member (44) vertically upwards, the gears (80) drive the upper roller bushing (76) and the cable pulls upwardly to elevate the lifting member (44). The lower roller bushing (78) meanwhile turns passively during this movement. For moving the lifting member (44) vertically downwards, the gears (80) drive the lower roller bushing (78) and the cable pulls downwardly via the spring to lower the lifting member (44). The upper roller bushing (76) meanwhile turns passively during this movement.

In one embodiment, a single portable hand control unit controls all operating functions; for example, while standing on the platform, the workman can safely and conveniently raise or lower the platform at the desired height, or extend or retract the platform to the desired extension distance. Additional control units can be provided in the vehicle, the vehicle bed, or on ground level to provide safety overrides or master or emergency shut-offs. A main key disconnect switch can be also provided to prevent unauthorized use.

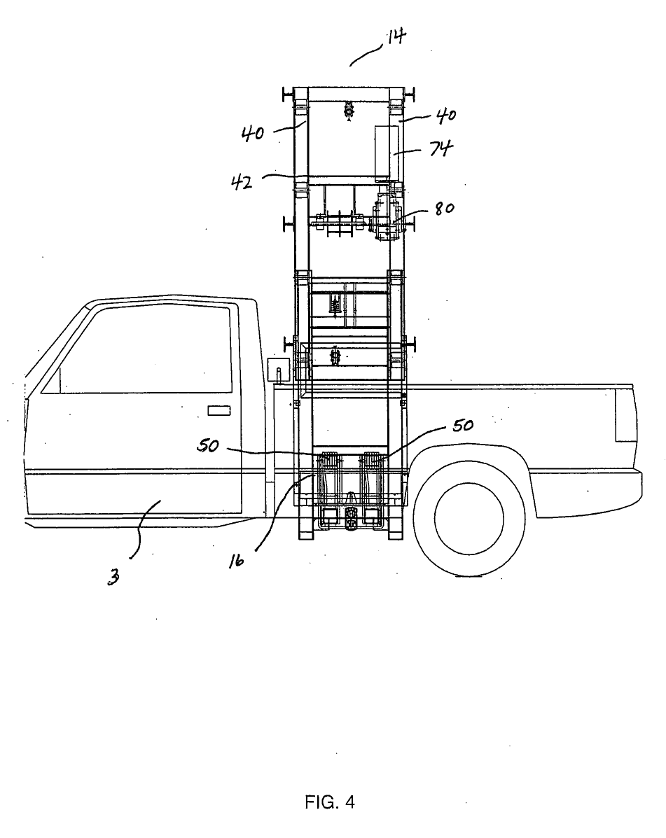

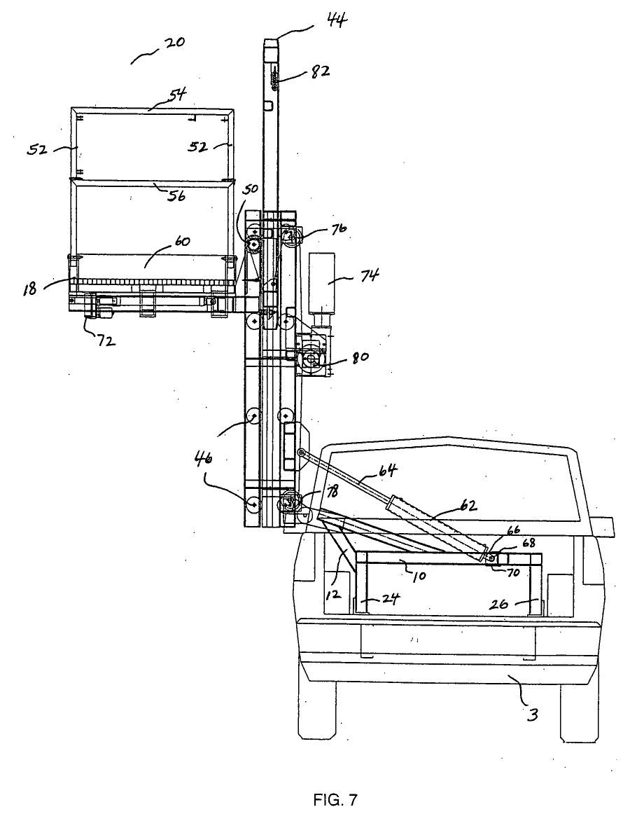

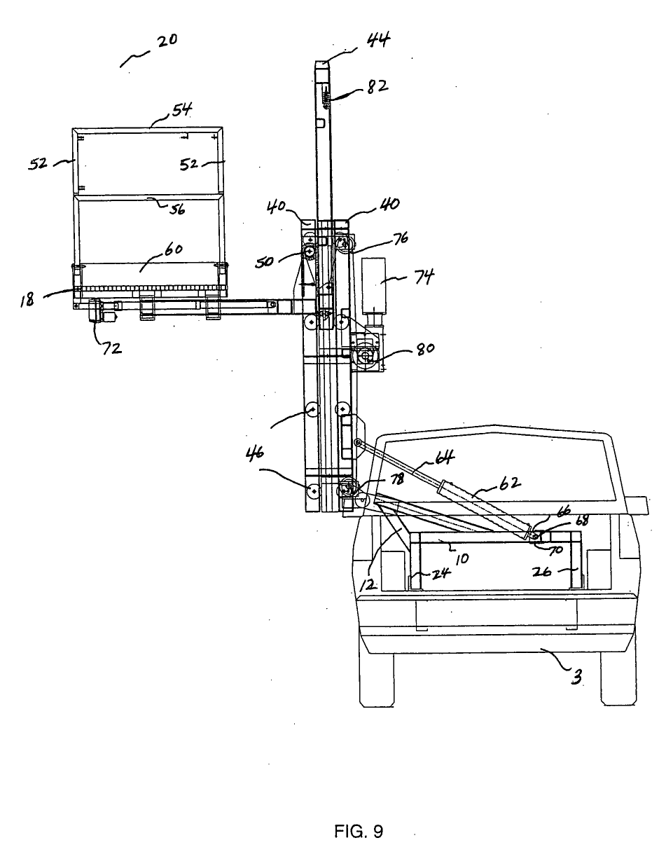

In operation, the retractable aerial platform (1) is installed within the bed (2) of the vehicle (3), with the first and second support members (14, 16) in the closed position, and the frame (20) in the collapsed position as shown in FIG. 1. The vehicle (3) is driven to the desired worksite and maneuvered into position adjacent the elevated structure or site. As shown in FIG. 2, the aerial platform (1) is elevated into a full upright position using the control unit. If desired, electric or manual levelers (not shown) may be lowered prior to operating the aerial platform (1) to minimize truck roll. As shown in FIGS. 3 and 4, the lifting member (44) is electrically lowered short of ground level. The platform (18) naturally folds down to provide easy and safe access, as shown in FIG. 5. The workman can then erect the frame (20) from a collapsible to a fully interlocked and upright position (shown in FIG. 6) by pulling upwardly on the hand rails (54). The workman can then stand upon the platform (18). Using the single portable control unit or assistance from other workmen operating control units in the vehicle or at ground level, the workman can adjust the height (as shown in FIGS. 6 and 7) and extension distance (as shown in FIG. 9) of the platform (18) to begin work functions.

Once the work has been completed, the lifting member (44) is lowered short of ground level. In one embodiment, the platform (18) is safely lowered by multiple stops and starts. In one embodiment, a gear drive brake is included to avoid back drive or slippage on momentum as the platform (18) is lowered. The workman can then exit the platform (18) and fold the frame (20) into the platform base (18) (FIG. 5). The lifting member (44) is raised to nest between the rollers (46) in preparation for closing (FIG. 2). The aerial platform (1) is then lowered into its closed position within the bed (2) of the vehicle (3). The platform (18) automatically drops back to rest on top of the first support member (14) (FIG. 1).

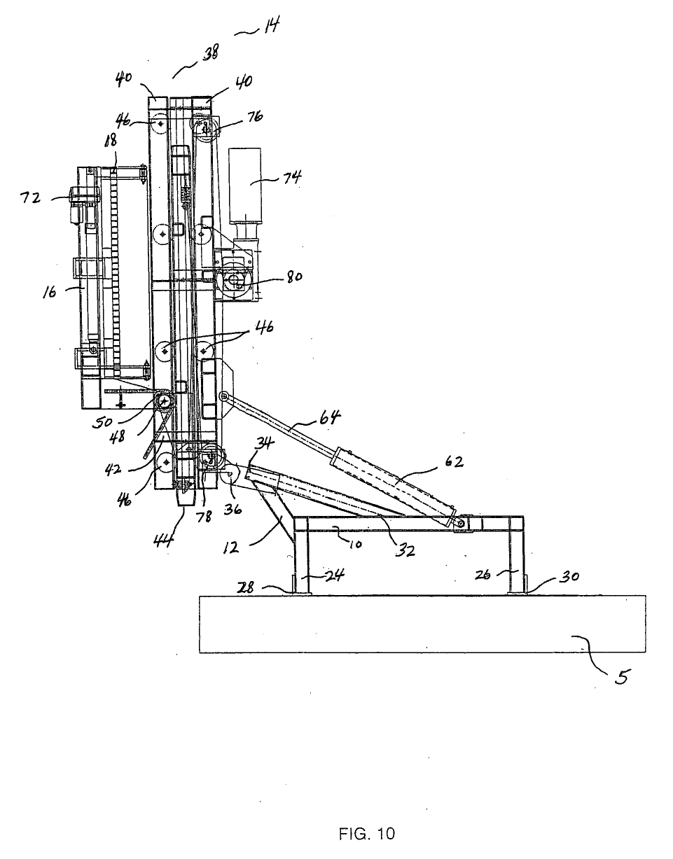

The embodiment of the invention described above is directed to a retractable aerial platform (1) that is mountable on the bed (2) of a vehicle. However, one skilled in the art will understand that the retractable aerial platform (1) of the present invention is not restricted to vehicle mounting and it can be mounted to any stable and substantially horizontal surface that will support the weight of the apparatus. FIG. 10 depicts an embodiment where the retractable aerial platform is mounted to a horizontal surface (5).

The present invention is advantageous over designs of the prior art. Importantly, there is provided a vertically and horizontally-controlled retractable aerial platform which allows the workman to adjust both the height and extension distance of the platform so that work functions can be readily performed. The aerial platform is portable, compact and suitable for use in a variety of commercial vehicles. The aerial platform features safety and fall protection by inclusion of hand rails, side rails and crossbeams within the frame; a slip-resistant platform surface; and a single portable hand control unit operable by a workman on the platform. The aerial platform is constructed of durable materials which can withstand heavy industrial and cold winter environments. Minimal handling is required since both assembly and disassembly of the aerial platform are electrically or hydraulically operated, or by a combination of both.

As will be apparent to those skilled in the art, various modifications, adaptations and variations of the foregoing specific disclosure can be made without departing from the scope of the invention claimed herein.

What is claimed is:

1. A retractable aerial platform mountable on a vehicle having a substantially horizontal bed with a longitudinal axis, the aerial platform comprising:
a) a base mounted on the bed;
b) at least one support arm having a first end and a second end, the first end being attached to the base;
c) a first support member pivotally attached to the second end of the at least one support arm, the first support member being movable between a closed position wherein it rests in a plane that is substantially parallel to the bed, and an open position wherein it rests in a substantially vertical orientation in a plane that is perpendicular to the bed;
d) a second support member pivotally attached to the first support member, the second support member being movable between a closed position wherein it rests in a plane that is substantially parallel to the first support member, and an open position wherein it rests in a substantially horizontal plane perpendicular to the first support member in its open vertical position and perpendicular to the longitudinal axis of the bed, wherein the second support member is movable along the length of the first support member;
e) a platform mounted on the second support member, wherein the platform is movable along the length of the second support member; and
f) actuation means for moving the first and second support members between the open and closed positions, for moving the second support member along the length of the first support member and for moving the platform along the length of the second support member.

2. The aerial platform of claim 1, wherein the platform further comprises a collapsible frame mounted on the platform moveable between a first collapsed position wherein the frame is substantially parallel to the platform and a second erect upright position.

3. The aerial platform of claim 1, wherein the base comprises first and second spaced leg members which extend downwardly from the base for attachment to the bed.

4. The aerial platform of claim 1, wherein the first support member comprises a frame having first and second spaced parallel side members reinforced by crossbeams, and a lifting member moveable longitudinally between the first and second side members, the second support member being pivotally attached to the lifting member.

5. The aerial platform of claim 4, wherein the first support member further comprises a plurality of spaced parallel rollers arranged in pairs within the first and second side members for lowering or raising the lifting member longitudinally between the first and second side members.

6. The aerial platform of claim 4, wherein the first support member further comprises a chain-based system for lowering or raising the lifting member longitudinally between the first and second side members.

7. The aerial platform of claim 1, wherein the collapsible frame comprises side rails positioned on the edges of the platform and extending vertically, and hand rails and crossbeams extending horizontally to connect the opposite side rails.

8. The aerial platform of claim 1, wherein the actuation means is selected from a hydraulic system, an electric system, or a hydraulic and electric based system.

9. The aerial platform of claim 8, wherein the actuation means for moving the first and second support members between open and closed positions comprises a hydraulic cylinder having a piston rod, the hydraulic cylinder being pivotally mounted to the base and the piston rod being pivotally mounted to the first support member.

10. The aerial platform of claim 8, wherein the actuation means for moving the platform along the length of the second support member comprises an electric actuator driven by an electric motor to extend or retract the platform horizontally along the second support member away from or towards the first support member.

11. The aerial platform of claim 10, wherein the electric actuator comprises a worm gear.

12. The aerial platform of claim 8, wherein the actuation means for moving the second support member along the length of the first support member comprises an electric motor positioned on the first support member and associated with gears to drive a cable-driven system to enable vertical upward and downward movement of the lifting member.

13. The aerial platform of claim 12, wherein the cable-driven system comprises upper and lower roller bushings at the ends of the first support member, a spring within the upper end of the lifting member, cable running from the gears to the lower roller bushing and connected to the spring, and cable running from the gears to the upper roller bushing and connected to the lower end of the lifting member.

14. The aerial platform of claim 7, further comprising a control unit selected from a portable hand control unit, a vehicle positioned control unit, or a ground level control unit.

15. The aerial platform of claim 1, wherein the platform is grated or comprises a metal floor grille or lattice.

16. The aerial platform of claim 1, further comprising two opposing end members and two opposing lateral members attached to the platform and frame to form an enclosure.

17. The aerial platform of claim 1, wherein at least one support arm is branched forming a “v” shape, the apex of the v being pivotally attached to the first support member.

18. The aerial platform of claim 1 comprising two support arms.

19. A retractable aerial platform mountable on a substantially horizontal surface, the aerial platform comprising:
a) a base mounted on the horizontal surface;
b) at least one support arm having a first end and a second end, the first end being attached to the base;
c) a first support member pivotally attached to the second end of the at least one support arm, the first support member being movable between a closed position wherein it rests in a plane that is substantially parallel to the horizontal surface, and an open position wherein it rests in a substantially vertical orientation in a plane that is perpendicular to the horizontal surface;
d) a second support member pivotally attached to the first support member, the second support member being movable between a closed position wherein it rests in a plane that is substantially parallel to the first support member, and an open position wherein it rests in a substantially horizontal plane perpendicular to the first support member in its open vertical position, wherein the second support member is movable along the length of the first support member;
e) a platform mounted on the second support member, wherein the platform is movable along the length of the second support member; and
f) actuation means for moving the first and second support members between the open and closed positions, for moving the second support member along the length of the first support member and for moving the platform along the length of the second support member.
